(19) United States
(12) Patent Application Publication
(10) Pub. No.: US 2004/0268216 A1
(43) Pub. Date: Dec. 30, 2004

(54) Method and apparatus for transferring a document into a folder

(76) Inventors: Paul E. Jacobs, La Jolla, CA (US); Bill Ganon, La Jolla, CA (US); Steven Dorner, San Diego, CA (US)

Correspondence Address: Qualcomm Incorporated, Patents Department, 5775 Morehouse Drive, San Diego, CA, 92121-1714, US

(21) Appl. No.: 10/606,129

(22) Filed: Jun. 24, 2003

(51) Int. Cl. G06F 15/00

(52) U.S. Cl. 715/500

(57) ABSTRACT

The disclosed embodiments provide methods and apparatus for transferring a document into a folder. In one aspect, a method for transferring a document into a folder includes identifying a portion of a document and transferring the document into a folder associated with the identified portion.

### FIELD

The present invention relates to transferring a document into a folder. More specifically, the present invention relates to methods and apparatus for transferring a document into a folder associated with an identified portion of the document.

### BACKGROUND

A user of an electronic mail (e-mail) service, who receives and sends numerous e-mails daily, often desires to save the e-mails into relevant mailbox folders. The user often creates such mailboxes and then causes each e-mail to be transferred into a relevant mailbox, a process that slows down the user. There is a need, therefore, for mechanisms to efficiently transfer e-mail documents into relevant mailbox folders.

### SUMMARY

The disclosed embodiments provide novel and improved methods and apparatus for transferring a document into a folder. In one aspect, a method for transferring a document into a folder includes identifying a portion of the document and transferring the document into a folder associated with the identified portion.

In one aspect, an apparatus for transferring a document into a folder includes an input device capable of receiving information, a memory unit capable of storing information, and a processor communicatively coupled with the input unit and the memory unit. The processor is capable of carrying out the above-mentioned methods.

### BRIEF DESCRIPTION OF THE DRAWINGS

The features and advantages of the present invention will become more apparent from the detailed description of disclosed embodiments set forth below when taken in conjunction with the drawings, and wherein:

FIG. 1 illustrates an e-mail document with a highlighted word therein;

FIG. 2 illustrates a message indicating that the e-mail document of FIG. 1 is being transferred into a folder associated with the highlighted word in FIG. 1;

FIG. 3 illustrates the e-mail document of FIG. 1 having been transferred into the folder associated with the highlighted word in FIG. 1;

FIG. 4 illustrates the e-mail document of FIG. 1 with a second highlighted word therein;

FIG. 5 illustrates the e-mail document of FIG. 1 having been transferred into the folder associated with the first highlighted word in FIG. 1 and the folder associated with the second highlighted word in FIG. 4;

FIG. 6 is a high-level diagram of a computer system including a plurality of client devices connected to a plurality of independently-operated server devices via a network, which computer system is suitable for implementing various disclosed embodiments; and

FIG. 7 is a high-level diagram of a representative one of the client devices illustrated in FIG. 6.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

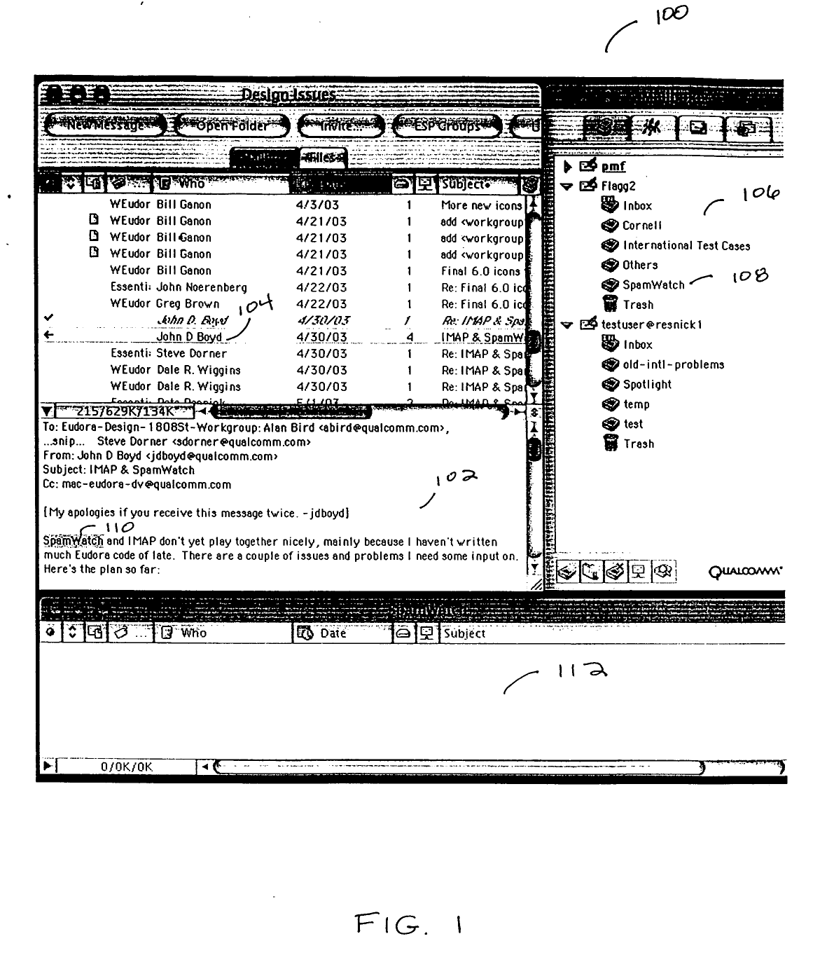

FIG. 1 illustrates a user interface 100 corresponding to an e-mail program operating within a personal computer system, personal digital assistant (PDA), a wireless phone, and the like. The user interface 100 shows an e-mail document 102 corresponding to the e-mail 104 received in the inbox mailbox. User interface 100 also shows a mailbox tree 106, illustrating the existing mailboxes. One such mailbox is “SpamWatch” mailbox 108 created for saving e-mail document(s) associated with Spam Watch. User interface 100 also shows the window 112 showing the content of mailbox folder “SpamWatch” 108.

A user of the e-mail program, who has received or sent an e-mail and is viewing the corresponding e-mail document or text, may wish to save the e-mail into a folder.

According to one embodiment, the user may identify a portion, such as a word, a symbol, or the like, within the e-mail document and cause the e-mail document to be transferred into a folder associated with the identified portion within the document. The user may identify the portion within the document by highlighting, clicking on, speaking, or touching the portion. For example, the user highlights the word “SpamWatch” 110 within e-mail document 102, as shown in FIG. 1, and clicks on the highlighted word 110 to be transferred to “SpamWatch” mailbox 108.

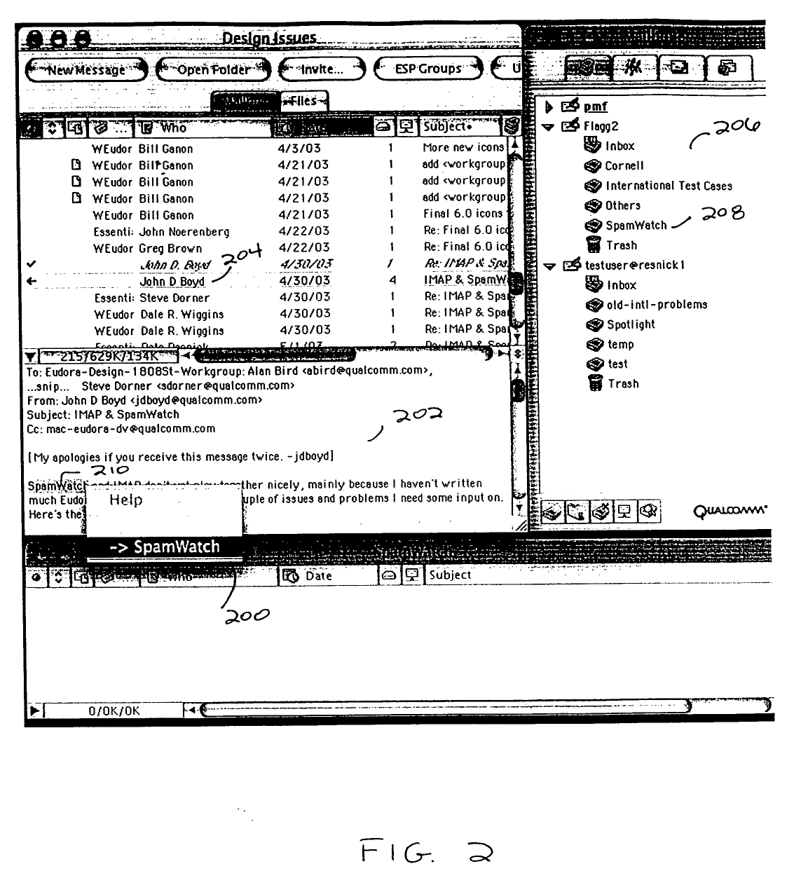

FIG. 2 illustrates a message 200, indicating that e-mail 204 is being transferred into the pre-existing mailbox “SpamWatch” 208 associated with the highlighted word “SpamWatch” 210. If none of the existing mailboxes in the mailbox tree 206 associate with a highlighted word, a new mailbox may be created, as will be discussed below.

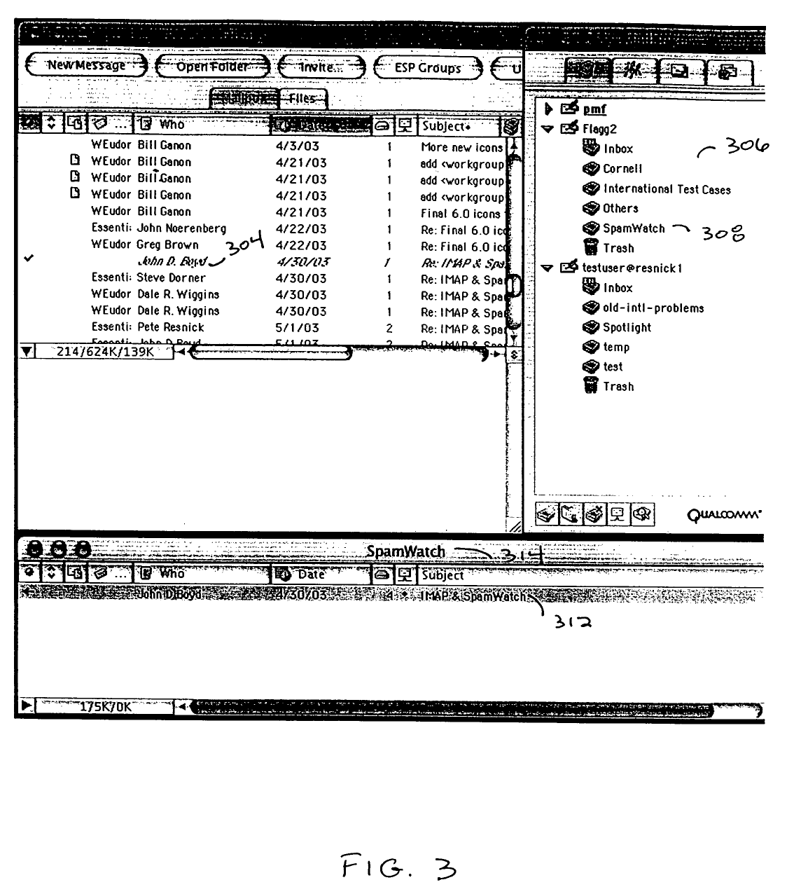

FIG. 3 illustrates an indication that that the e-mail 304 has been transferred, as e-mail 312, into mailbox folder “SpamWatch” 308. The content of “SpamWatch” mailbox 308 may be shown in window 314, showing e-mail 312 transferred therein.

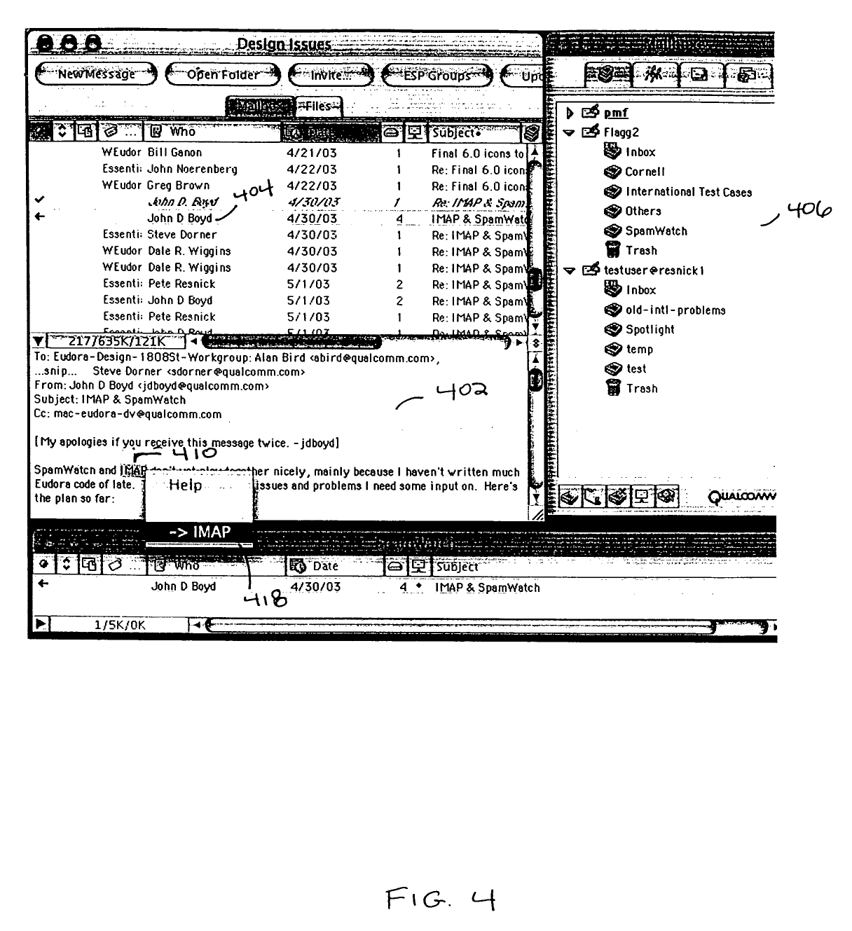

The user may identify more than one portion of the same document and cause the same document to be transferred into more than one mailbox associated with respective identified portions. For example, as shown in FIG. 4, the user highlights the second word “IMAP” 410 within the e-mail document 402, and clicks on the second highlighted word 410 to transfer e-mail 404 into a folder associated with the second highlighted word 410. However, in this case, no folder associated with the second highlighted word 410 exists, as none is shown in mailbox tree 406. FIG. 4 illustrates a message 418, indicating that the e-mail 404 is being transferred into the to-be-created mailbox ” AP” associated with the highlighted word 410. The new mailbox “IMAP” may be created based on the highlighted word, e.g., “IMAP.”

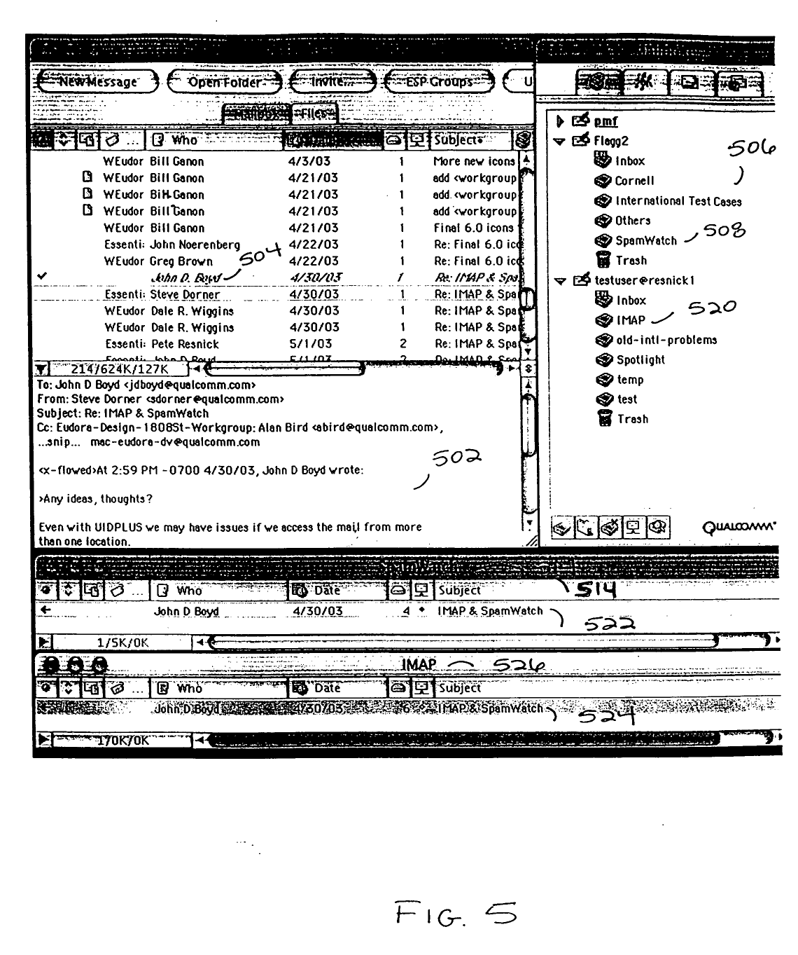

FIG. 5 illustrates an indication that that the e-mail 504 has been transferred into the newly created mailbox folder “IMAP” 520, as e-mail 524, associated with the second highlighted word. The content of “IMAP” mailbox 520 may be shown in window 526, showing e-mail 524 transferred therein. In one embodiment, FIG. 5 also illustrates an indication that the same e-mail 504 had been previously transferred into mailbox folder “SpamWatch” 508 associated with the first highlighted word. The content of “SpamWatch” mailbox 508 may be shown in window 514, showing e-mail 522 transferred therein.

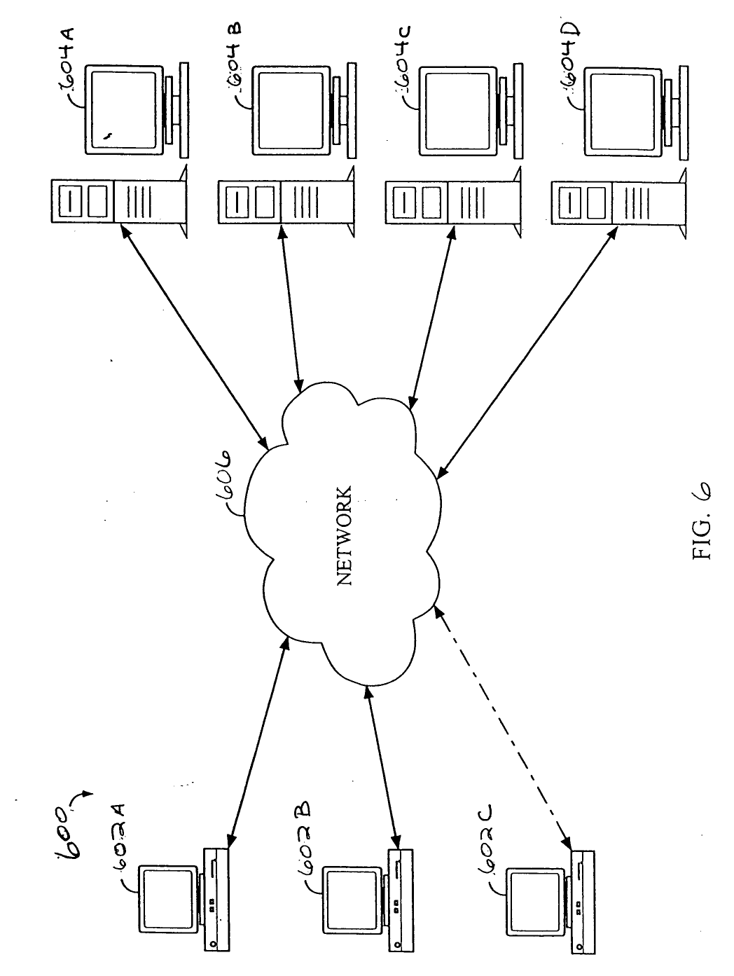

FIG. 6 illustrates system configuration 600 that is suitable for carrying out the functions according to the disclosed embodiments. Although the disclosed embodiments are generally described with respect to an electronic mail (e-mail) system where a number of users can create, send, receive and read e-mail messages, the disclosed embodiments are not so limited. For example, the disclosed embodiments are equally applicable to a personal digital assistant (PDA) incorporating specialized software for receiving stock quotations via a wireless network. Thus, the principles of the disclosed embodiments should not be regarded as limited solely to e-mail systems; the principles of the disclosed embodiments apply to on-line services where a provider, e.g., a software provider, desires to make its software available to users.

As shown in FIG. 6, the system 600 includes a plurality of client computers 602A, 602B, 602C. Each of the client computers generally denoted 602 can be either a workstation or a personal computer executing a client program. In one embodiment, the client computers 602A-602C advantageously can be connected to a plurality of servers 604A-604D, via a network 606, e.g., the Internet. Alternatively, the network 606 may be one of a local area network (LAN), a wide area network (WAN), an Intranet, or a wireless network, or some combination thereof. It will be appreciated that FIG. 6 illustrates a non-limiting exemplary system; and number of clients can be connected to any number of servers.

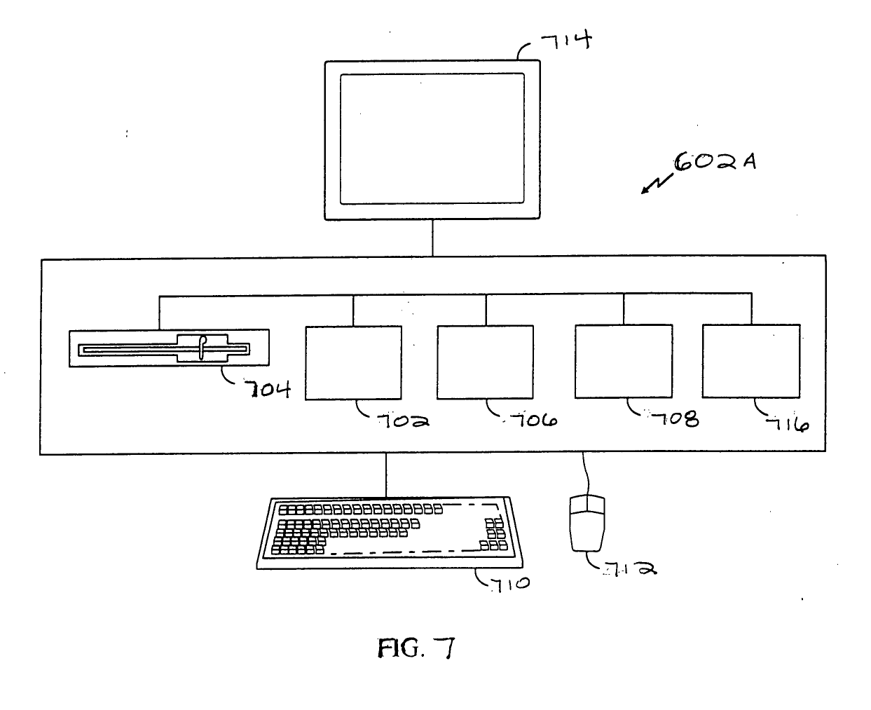

FIG. 7 illustrates in further detail the hardware configuration of an exemplary one of the client computers 602A-602C illustrated in FIG. 6. In one embodiment, the client computer 602A includes a central processing unit 702 for executing computer programs (including the client program according to one embodiment) and managing and controlling the operation of the client computer 602A. A storage device 704, such as a floppy disk drive, is coupled to the central processing unit 702 for, e.g., reading and writing data and computer programs to and from removable storage media such as floppy disks. Storage device 706, coupled to the central processing unit 702, also provides a mechanism for storing computer programs and data. Storage device 706 includes a hard disk having a high storage capacity. A dynamic memory device 708 such as a RAM, is also coupled to the central processing unit 702. It will be noted that storage devices 704 and 706, as well as dynamic memory device 708, are non-limiting examples of a memory unit. The client computer 602A includes input/output devices, such as, for example, a keyboard 710, a mouse 712, a monitor 714, and a communications device 716. It will be appreciated that the communications device advantageously can be a modem, an ethernet interface card, etc.

Therefore, the disclosed embodiments provide for an efficient mechanism for transferring a document in to a folder based identifying a portion of the document and causing the document to directly transfer to the folder associated with the identified portion.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.”

1. A method for transferring a document into a folder, the method comprising:
identifying a portion of a document; and
transferring the document into a folder associated with the identified portion.

2. The method of claim 1, wherein said identifying includes selecting a word within the document.

3. The method of claim 1, wherein said identifying includes selecting a symbol within the document.

4. The method of claim 1, wherein said identifying includes clicking on the portion.

5. The method of claim 1, wherein said identifying includes speaking the portion.

6. The method of claim 1, wherein said identifying includes touching the portion.

7. The method of claim 1, wherein the folder includes a pre-established folder.

8. The method of claim 1, further indicating that the document is being transferred into the folder.

9. The method of claim 1, further indicating that the document has been transferred into the folder.

10. The method of claim 1, further indicating that the document is being transferred into a second folder associated with a second identified portion.

11. The method of claim 1, further indicating that the document has been transferred into a second folder associated with a second identified portion.

12. The method of claim 11, wherein the second folder includes a pre-established folder.

13. The method of claim 11, wherein the second folder includes a newly established folder based on the second identified portion.

14. A computer-readable medium storing codes for enabling a processor to perform a method for transferring a document into a folder, the method comprising:
identifying a portion of a document; and
transferring the document into a folder associated with the identified portion.

15. The computer-readable medium of claim 14, wherein said identifying includes selecting a word within the document.

16. The computer-readable medium of claim 14, wherein said identifying includes selecting a symbol within the document.

17. The computer-readable medium of claim 14, wherein said identifying includes clicking on the portion.

18. The computer-readable medium of claim 14, wherein said identifying includes speaking the portion.

19. The computer-readable medium of claim 14, wherein said identifying includes touching the portion.

20. The computer-readable medium of claim 14, wherein the folder includes a pre-established folder.

21. The computer-readable medium of claim 14, further indicating that the document is being transferred into the folder.

22. The computer-readable medium of claim 14, further indicating that the document has been transferred into the folder.

23. The computer-readable medium of claim 14, further indicating that the document is being transferred into a second folder associated with a second identified portion.

24. The computer-readable medium of claim 14, further indicating that the document has been transferred into a second folder associated with a second identified portion.

25. The computer-readable medium of claim 24, wherein the second folder includes a pre-established folder.

26. The computer-readable medium of claim 24, wherein the second folder includes a newly established folder based on the second identified portion.

27. An apparatus for transferring a document into a folder, comprising:
means for identifying a portion of a document; and
means for transferring the document into a folder associated with the identified portion.

28. The apparatus of claim 27, wherein said means for identifying includes means for selecting a word within the document.

29. The apparatus of claim 27, wherein said means for identifying includes means for selecting a symbol within the document.

30. The apparatus of claim 27, wherein said means for identifying includes means for clicking on the portion.

31. The apparatus of claim 27, wherein said means for identifying includes means for speaking the portion.

32. The apparatus of claim 27, wherein said means for identifying includes means for touching the portion.

33. The apparatus of claim 27, wherein the folder includes a pre-established folder.

34. The apparatus of claim 27, further including means for indicating that the document is being transferred into the folder.

35. The apparatus of claim 27, further including means for indicating that the document has been transferred into the folder.

36. The apparatus of claim 27, further including means for indicating that the document is being transferred into a second folder associated with a second identified portion.

37. The apparatus of claim 27, further including means for indicating that the document has been transferred into a second folder associated with a second identified portion.

38. The apparatus of claim 37, wherein the second folder includes a pre-established folder.

39. The apparatus of claim 37, wherein the second folder includes a newly established folder based on the second identified portion.

40. An apparatus for transferring a document into a folder, comprising:
an input device capable of receiving information;
a memory unit capable of storing information; and
a processor communicatively coupled with the input unit and the memory unit, the processor capable of carrying out a method for transferring a document into a folder, the method comprising:
identifying a portion of a document; and
transferring the document into a folder associated with the identified portion.

41. The apparatus of claim 40, wherein said identifying includes selecting a word within the document.

42. The apparatus of claim 40, wherein said identifying includes selecting a symbol within the document.

43. The apparatus of claim 40, wherein said identifying includes clicking on the portion.

44. The apparatus of claim 40, wherein said identifying includes speaking the portion.

45. The apparatus of claim 40, wherein said identifying includes touching the portion.

46. The apparatus of claim 40, wherein the folder includes a pre-established folder.

47. The apparatus of claim 40, the method further indicating that the document is being transferred into the folder.

48. The apparatus of claim 40, the method further indicating that the document has been transferred into the folder.

49. The apparatus of claim 40, the method further indicating that the document is being transferred into a second folder associated with a second identified portion.

50. The apparatus of claim 40, the method further indicating that the document has been transferred into a second folder associated with a second identified portion.

51. The apparatus of claim 50, wherein the second folder includes a pre-established folder.

52. The apparatus of claim 50, wherein the second folder includes a newly established folder based on the second identified portion.
